(19) United States
(12) Patent Application Publication
(10) Pub. No.: US 2008/0246894 A1
(43) Pub. Date: Oct. 9, 2008

(54) Security Document Incorporating Optical Component

(75) Inventors: Gary Power, Victoria (AU); Paul Zientek, Victoria (AU)

Correspondence Address: GREER, BURNS & CRAIN, 300 S WACKER DR, 25TH FLOOR, CHICAGO, IL, 60606, US

(73) Assignee: SECURENCY PTY LIMITED, Craigieburn (AU)

(21) Appl. No.: 10/585,791

(22) PCT Filed: Jan. 11, 2005
(86) PCT No.: PCT/AU2005/000021

§ 371 Date: Jun. 19, 2008

(30) Foreign Application Priority Data
Jan. 12, 2004 (AU) 2004900133

(51) Int. Cl. G02F 1/13

(52) U.S. Cl. 349/1; 349/187

(57) ABSTRACT

A security document or device (30) is provided which has a substrate (31) including at least one layer (35,37) of polymeric material and an optical component formed by at least one orientating (PPN) layer (34) and at least one liquid crystal polymer (LCP) layer (36) in contact with the orientating layer (34). An intermediate prime layer (38) is provided between the optical component and the substrate (31) which improves the adhesion of the optical component to the substrate (31). The prime layer (38) may include a hydroxyl terminated polymer which is cross-linked by a multifunctional isocyanate. A security document with such a prime layer between the optical component and a polymeric surface of the substrate is more robust and able to withstand rough treatment without significantly affecting the optical properties of the optical component.

This invention relates to security documents, and is particularly concerned with security documents incorporating optical components which have at least one orientating layer provided on a substrate and at least one layer of a liquid crystal polymer (LCP) over the orientating layer.

U.S. Pat. No. 6,160,597 discloses a multi-layer optical component and a method of manufacture in which an orientating layer is applied on to at least one surface of a substrate, e.g. a glass plate, a layer of non-cross-linked liquid crystalline monomer is applied onto the orientating layer, and then the monomer is cross-linked to form a liquid crystalline polymer (LCP) layer. If required, additional orientating layers and liquid crystal layers may be applied to form more complex multi-layer structures.

These multi-layer structures can be used in optical and electro-optical devices, such as in the manufacture of liquid crystal calls, in which the various orientating and LCP layers serve different optical and orientating purposes.

It has also been proposed that the multi-layer optical components disclosed in U.S. Pat. No. 6,160,597 could be used as a safeguard against counterfeiting and copying. However, this has proved difficult in practice because we have found that a multi-layer structure of at least one orientating layer and at least one LCP layer lacks sufficient adhesion when provided on a flexible substrate of a security document, for example a polymeric substrate or a paper substrate with a polymeric coating. This problem is particularly exacerbated with security documents which are in frequent use, such as banknotes, which are required to be robust to withstand wear, folding and other rough treatment when in circulation.

It is therefore desirable to provide a security document incorporating an optical component of the type disclosed in U.S. Pat. No. 6,160,597 which is robust and able to withstand rough treatment without significantly affecting the optical properties of the optical component.

It is also desirable to provide an improved optical component for use as a security device in a security document.

It is further desirable to provide a method of manufacturing a security document or device incorporating an optical component of the type described above.

According to one aspect of the invention, there is provided a security document or device comprising:

a substrate including at least one layer of polymeric material;

an optical component formed by at least one orientating layer and at least one liquid crystal polymer layer in contact with the orientating layer; and

an intermediate layer provided between the optical component and the substrate which improves the adhesion of the optical component to the substrate.

The intermediate layer preferably comprises a primer layer, and more preferably the primer layer includes a hydroxyl terminated polymer. The primer layer may also include a cross-linker, for example a multi-functional isocyanate. Examples of primers suitable for use in the invention include: hydroxyl terminated polyester based co-polymers; polyethylene imine; cross-linked or uncross-linked hydroxylated acrylates; polyurethanes; and UV curing anionic or cationic acrylates. Examples of suitable cross-linkers include: isocyanates; polyaziridines; ziconium complexes; aluminium acetylacetone; melamines; and carbodi-imides,

The type of primer may vary for different substrates and orientating layers. Preferably, a primer is selected which does not substantially affect the alignment of the orientating layer.

In one preferred embodiment, the substrate is formed from a polymeric material. Preferably, the substrate includes at least one layer of biaxially oriented polymeric material. For example, the substrate may comprise a base layer of at least two films of transparent biaxially oriented polymeric material laminated together, such as described in WO 83/00659. The substrate may also include one or more co-polymer layers on one or both sides of the base layer of biaxially oriented polymeric material. Alternatively, the substrate may comprise a base layer of paper with at least one polymeric coating, e.g. a co-polymer, provided on one or both sides of the base layer.

The substrate may also include at least one opacifying coating applied on at least one side of the base layer, particularly when the base layer is formed from a transparent polymeric material. The at least one opacifying coating may completely cover the surface of the transparent substrate. Alternatively, the at least one opacifying coating may only partially cover the transparent substrate so as to form at least one transparent portion or window which is not covered by the opacifying coating.

The orientating layer and the liquid crystal polymer layer may be applied to cover the entire surface of the substrate, for example to form a stand-alone security device which may be attached to another article, such as a security document.

Alternatively, the orientating layer and the LCP layer may be applied over a selected region or regions of the substrate. For example, for a security document which includes a transparent portion or window, the orientating layer and the LCP layer may be applied wholly within the area of the window, partially within and partially outside the area of the window, or wholly outside the window.

The orientating layer is preferably in intimate contact with the LCP layer. The orientating layer preferably comprises a photo-alignment layer, such as a photo-orientated polymer network (PPN—synonymous with LPP in other literature), such as described in U.S. Pat. No. 5,602,661, the contents of which are incorporated herein by reference. Instead of the PPN layer, the orientating layer may comprise a more conventional orientating layer, such as a polyimide layer rubbed in one direction or a layer having an orientating effect and obtained by oblique sputtering with SiOₓ. Another possibility is to apply a PPN layer to a conventionally orientated layer previously deposited on the substrate.

The LCP layer preferably comprises an anisotropic layer of orientated cross-linked liquid crystal monomers. The LCP layer has an arrangement of molecules having an orientation determined by the orientation of the underlying orientating layer or transferred therefrom to the LCP layer. The LCP layer may be photo-cross-linked by the action of light of a suitable wavelength and retains the orientation of molecules predetermined by the orientating layer. The photo cross-linking fixes the orientation of the LCP layer so that it is unaffected by extreme external influences such as light or high temperatures.

The security document or device may include further orientating layers and/or LCP layers. For example, two or more orientating layers and LCP layers having different orientation patterns may be provided to form a stack of orientation layers and LCP layers on a substrate as disclosed in U.S. Pat. Nos. 5,602,661 and 6,160,597, the contents of which are incorporated herein by reference.

The security document or device may also include other layers, such as a reflector layer or a polarizing layer. For example, U.S. Pat. No. 6,144,428 discloses a reflective metal layer between the orientation layer and the substrate. The polarising layer may be a photo oriented polymer network (PPN) with a liquid crystal polymer (LCP) and a cross-linked dichroic dye added to form the polariser. However, other forms of polarisers may be used to form the polarising layer. WO 98/52077 discloses a linear polarizer between the orientation layer and the substrate. If the security document or device includes a reflector or a linear polarizer, the optical effects produced by the LCP layer and orientating layer in combination may be viewed using a single polarizer, instead of requiring cross-polarizers to view the effects.

The optical component formed by the combination of the LCP layer(s) and orientation layer(s) may contain two or more hidden images, such as described in WO 00/29878. These images may be successively revealed and concealed when the optical component is held between two polarizers and one of them is rotated.

According to another aspect of the invention, there is provided a method of manufacturing a security document or device comprising:

providing a substrate which includes at least one layer of polymeric material;

applying a primer layer on at least one side of the substrate;

applying an orientating layer over the primer layer;

aligning the molecules of the orientating layer; and

applying a liquid crystal polymer (LCP) layer over the orientating layer.

Preferably, the orientating layer comprises a photoalignment layer which is exposed to polarized light to align the molecules of the photoalignment layer.

The photoalignment may be subjected to a first exposure of polarized light through a mask to form local regions having a first orientation of molecules, The layer may then be subjected to a second exposure without a mask using a different component of the polarized light to form local regions having a second orientation to form an orientation pattern in the orientating layer.

Alternatively, an orientation pattern may be formed in the photo-alignment layer and/or the LCP layer without the use of a mask, for example in a variable printing process or a laser writing process, such as described in our International Patent Application No. WO03/106188, the contents of which are incorporated herein by reference.

The LCP layer may be formed by applying a coating of liquid crystal monomers to the orientating layer and cross-linking the monomers to fix the orientation of the liquid crystal molecules as determined by the underlying orientation layer.

Preferred embodiments of the present invention will now be described, by way of example only, with reference to the accompanying drawings, in which:

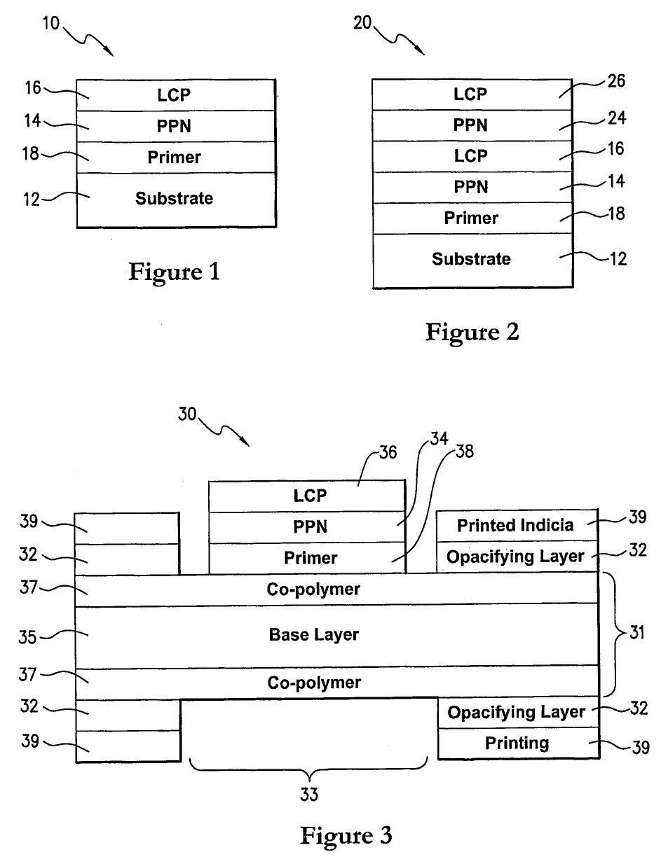

FIG. 1 is a schematic section through a first embodiment of a security device in accordance with the invention;

FIG. 2 is a schematic section through a second embodiment of a security device in accordance with the invention;

FIG. 3 is a schematic section through an embodiment of a security document in accordance with the invention;

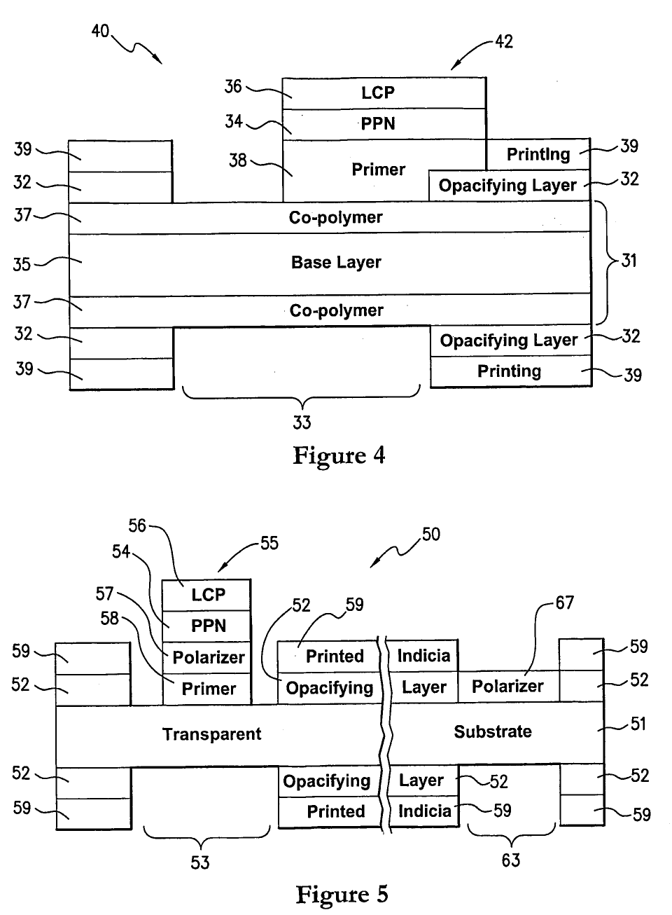

FIG. 4 is a schematic section through a modified security document in accordance with the invention;

FIG. 5 is a schematic section through another embodiment of a security document in accordance with the invention.

The security device 10 shown in FIG. 1 includes a substrate 12 formed from a polymeric material, an optical component formed by an orientating layer 14 and a liquid crystal polymer (LCP) layer 16 on the orientating layer 12, and an intermediate primer layer 18 between the substrate 12 and the orientating layer 14. The orientating layer 14 preferably comprises a photo-alignment layer, and more preferably comprises a photo-oriented polymer network (PPN) of the type described in U.S. Pat. No. 5,602,661. The photo-alignment (PPN) layer 14 is in intimate contact with the liquid crystal polymer (LCP) layer 16.

The molecules of the PPN orientating layer 14 are oriented by selective irradiation by linearly polarized UV light. If a mask is placed over the PPN layer during the irradiation process, an orientation pattern may be formed in the PPN orientating layer 14. The PPN layer 14 may be subjected to more than one exposure to different components of linearly polarized light to produce more complex patterns. In cases where a uniform orientation pattern is required in the orientating layer 14, a PPN layer may be subjected to a single exposure of linearly polarized light without a mask, or alternatively the orientating layer 14 may be a conventional orientating layer such as a polyimide layer rubbed in one direction or a layer having an orientating effect obtained by oblique sputtering with SiOₓ.

The LCP layer 16 preferably comprises an anisotropic layer of orientated cross-linked liquid crystal monomers which has an orientation determined by the underlying orientating layer 14. The orientation of the liquid crystal molecules in layer 14 is fixed by a photo-cross-linking process, such as described in U.S. Pat. No. 5,602,661.

The polymeric substrate 12 preferably comprises a transparent, biaxially orientated polymeric material, such as described in WO 83/00659. Polymeric substrates of this type have been used successfully in the manufacture of flexible security documents, such as banknotes, for Australian currency and the currency of several other countries, We have, however, discovered that when a security device comprising an orientating (PPN) layer and an LCP layer is applied directly applied to a thin, flexible substrate formed from or including a polymeric layer in the manufacture of a flexible security document, the adhesion of the orientating (PPN) layer to the substrate is not sufficiently robust to withstand wear, folding and other rough treatment to which the flexible security document or banknote is subjected in use, without adversely affecting the optical properties of the optical component formed by the PPN and LCP layers.

In the security device of FIG. 1, the primer layer 18 is provided to increase the adhesion between the substrate 12 and the orientating layer 14.

The primer layer 18 preferably includes two components: a polymer component and a cross-linker. The polymer component is preferably a hydroxyl terminated polymer, such as a hydroxyl terminated polyester. Other suitable polymers include polyethyleneimine; hydroxylated acrylates, which may be cross-linked or not cross-linked; polyurethanes and UV curing anionic or cationic acrylates. Suitable cross-linkers include isocyanates; polyaziridines; zirconium complexes; aluminium acetylacetone; melamines; and carbodi-imides, The primer is preferably pre-selected so that it will not adversely affect the photo-alignment of the molecules in the PPN orientating layer.

In a preferred method of manufacturing the security device of FIG. 1, the primer layer 18 is applied in solution to a surface on one side of the polymeric substrate 12 and after removal of the primer solvent, a solution containing the photo-orientating polymer network (PPN) is applied over the primer layer 18 to form the orientating layer 12. The substrate is then dried and the PPN solvent removed.

The PPN layer 16 is preferably applied to a thickness between about 2 nm and about 150 nm The photo-orientating polymer network (PPN) should not be soluble in the primer solvent, However, when the PPN layer 16 is dried, the primer layer 18 forms a strong adhesive bond between the PPN layer 16 and the polymeric substrate 12. Surprisingly it has also been found that the primer layer 18 also increases the robustness of the optical component formed by PPN layer 14 and the LCP layer 16.

The PPN layer 14 is then subjected to at least one exposure of linearly polarized light to orientate the molecules of the PPN layer 14. Preferably, the PPN layer 14 is subjected to a first exposure through a mask to one component (e.g. the p-component) of polarised light to form local regions having a first orientation and then to a second exposure to the other component (e.g. the s-component) of polarized light without a mask so that other regions of the PPN layer have a second orientation to form an orientation pattern in the orientating PPN layer 14.

A solution containing liquid crystal monomers is then applied over the PPN layer. The liquid crystal molecules assume the orientation of the underlying PPN layer 14. The solvent is then removed and the liquid crystal monomers are photo-cross-linked by an exposure to light of a suitable wavelength. The photo-cross-linking process fixes the orientation of the LCP layer 16 so that it has the same orientation pattern of the PPN layer 14.

In an alternative method, an orientation pattern may be formed in the PPN layer and/or the LCP layer without the use of a mask, eg by a variable printing process in which the PPN layer and/or the LCP layer are printed in a pattern representing the orientation pattern for a latent image, or by a laser writing process using a scribe laser to write the orientation pattern forming the latent image in the PPN layer and/or the LCP layer. Both these processes are described in detail in WO 03/106188, the contents of which are incorporated herein by reference.

The orientation pattern of the security device of FIG. 1 is normally invisible when observed in non-polarized light, but becomes visible when viewed using cross-polarizers. Alternatively, the security devices 10 may include a reflector layer or a polarizing layer (not shown) on the substrate 12 such as disclosed in U.S. Pat. No. 6,144,428 or WO 98/52077, the contents of which are incorporated herein by reference. In this case, with a reflector layer or a polarizing layer beneath the orientating layer 14, the orientation pattern may be viewed using a single polarizer.

The security device 10 of FIG. 1 may be attached to any article to provide a means of verifying that the article is authentic, but is particularly applicable to security documents and tokens which require protection against copying and counterfeiting. When the security device 10 is to be attached to another article, the PPN layer 14 and the LCP layer 16 preferably cover the entire surface of the substrate 12. Alternatively, the PPN and LCP layers 14 and 16 may only partially cover the surface of the substrate 12, for instance when the substrate 12 itself constitutes the base layer for a security document or token.

Referring to FIG. 2, there is shown a modified security device 20 which is similar to that of FIG. 1 and corresponding reference numerals have been applied to corresponding parts. The security device 20 differs from that of FIG. 1 in that it includes a second orientating layer 24 on the first LCP layer 16 and a second LCP layer 26 on the second orientating layer 24. The second orientating layer 24 preferably comprises a photo-orientated polymer network (PPN) which is applied to the first LCP layer 16 in similar manner as the first orientating (PPN) layer 14 is applied to the primer layer 18 on the substrate 12.

The second orientating (PPN) layer 24 is preferably exposed to linearly polarized light through a mask having a different pattern to the mask used to produce the orientation pattern in the first orientating (PPN) layer 14. Thus a different orientation pattern is formed in the second orientating (PPN) layer 24 and consequently when the second LCP layer 26 is applied in the form of a solution of liquid crystal monomers and photo-cross-linked to fix the orientation pattern, the second LCP layer 26 has a different pattern from the first LCP layer 16. Therefore, with a plurality of orientating layers 14, 24 and LCP layers 16, 26 with different orientation patterns, security devices which have more complex visual effects and which can store more information in the orientation patterns can be produced.

FIG. 3 shows an embodiment of a security document 30 in accordance with the invention which comprises a transparent substrate 31, and opacifying layers 32 provided on each side of the substrate 31 which only partially cover the substrate 31 to form a transparent portion or “window” 33 in the security document 30. In the region of the window 33, a security device comprising an orientating layer 34 and a liquid crystal polymer layer 36 is provided. As in the embodiment of FIG. 1, a primer layer 38 is provided between the orientating layer 34 and the substrate 31.

The substrate 31 of the security document 30 shown in FIG. 3 comprises a base layer 35 and polymer layers 37 provided on each side of the base layer 35. The base layer 35 is preferably formed a transparent biaxially orientated polymer material and the polymer layers 37 are preferably formed from co-polymers, such as polyethylene or polypropylene. For some applications, the co-polymer layer 37 on one or both sides of the base layer 35 may be omitted.

The opacifying layers 32 preferably comprise coatings containing at least one opacifying pigment. The opacifying coatings preferably include a major proportion of one or more pigmentary materials bound with a minor proportion of a cross-linkable polymeric binder, such as disclosed in WO 83/00659. The opacifying pigment or pigments may be selected from a group including titanium dioxide (Ti0₂), calcium carbonate (CaCO₃), barium sulphate (BaSO₄) and zinc oxide (ZnO), although it will be appreciated that other pigments may be used. One or more layers of printed indicia 39 may be provided on the opacifying layers 32.

The orientating layer 34 preferably comprises a photo-oriented polymer network (PPN). As in the security device of FIG. 1, the primer layer 38 is provided to increase the adhesion between the orientating PPN layer 34 and the co-polymer layer 37 of the substrate 31.

The primer layer 38 may be formed from the same materials as described with reference to FIG. 1, e.g. the primer may comprise a hydroxyl terminated polymer with a cross-linker such as an isocyanate. In addition to increasing the adhesion between the PPN orientating layer 34 and the co-polymer layer 37, the primer layer 38 has also been found to increase the robustness of the security device formed by the PPN layer 34 and the LCP layer 36. This is particularly important for flexible security documents, such as banknotes, which are subjected to wear, folding and other rough treatment when in circulation.

A modified embodiment of a security document 40 in accordance with the invention is shown in FIG. 4. The security document 40 is similar to the security document of FIG. 3, and corresponding reference numerals have been applied to corresponding parts. The security document 40 differs from that of FIG. 3 in that the primer layer 38, the orientating layer 34 and the LCP layer 36 are applied to the substrate 31 so that the security device 42 formed by the layers 34, 36 and 38 is provided partly in the transparent region or window 33 which is uncovered by the opacifying coating 32 and extends outside the window 33 to cover part of the opacifying coating 32 on one side of the substrate 31.

When viewed in polarized light the security device 42 in the security document 40 of FIG. 4 can produce different visual effects between the part of the device within the window 33 and the part of the device 42 on the opacifying layer outside the window 33.

In a modified embodiment similar to that of FIG. 4, the security device 42 formed by the orientating (PPN) layer 34 and the LCP layer 36 may be provided on the opacifying layer 32 totally outside the transparent region or window 33. In this case window 33 may incorporate other types of security devices, and the security device 42 may incorporate a reflective layer, such as a metallised layer, so that the security device 42 on the opacified layer 32 can be viewed using a single polarizer.

In another modified embodiment, the opacifying layer 32 on one or both sides of the substrate 31 may cover the entire surface or surfaces of the substrate 31, so that there is either a half window or no window at all. Again, it is desirable for the security device 42 to incorporate a reflective layer when the security device is provided wholly on an opacifying layer. In a further modified embodiment, the substrate 31 may comprise a base layer 35 of paper or fibrous material preferably covered on one or both sides by one or more polymeric layers 37 to improve the wear characteristics of the security document with a primer layer 38 provided between the orientating (PPN) layer 34 and the underlying polymeric layer 37.

Another embodiment of a security document 50 in accordance with the invention is shown schematically in FIG. 5. The security document 50 is similar to that of FIGS. 3 and 4 in that it comprises a flexible transparent polymeric substrate 52, opacifying layers 52 applied to the substrate 51 in such a manner as to cover the substrate 51 only partially to form a first transparent region or window 53 in which a security device 55 is provided. The security device 55 comprises an orientating (PPN) layer 54 and a liquid crystal polymer layer 56 formed in similar manner to the security devices of FIGS. 1 to 4. The security device 55 also includes a linear polarizer 57 below the PPN orientating layer 54. A primer layer 58 is provided between the security device 55 and the transparent substrate 51 to increase the adhesion between the substrate 51 and the PPN layer 54 and linear polarizer 57 of the security device 55 in similar manner to the embodiments of FIGS. 1 to 4. As the primer layer 58 may be formed from the same type of materials as in those earlier embodiments. For example, the primer may comprise a hydroxyl terminated polymer with a cross-linker, such as an isocyanate.

The transparent substrate 51 is preferably formed from a biaxially oriented polymeric material. The substrate 51 may also include co-polymer layers in similar fashion to the embodiments of FIGS. 3 and 4. The security document 50 also includes printed indicia 59 on the opacifying layers 52. The security document 50 differs from the documents of FIGS. 3 and 4 in that the opacifying layers 52 are also omitted in another area of the substrate 51 to form a second transparent portion or window 63 which is laterally spaced from the first window 53. A second polarizer 67 is provided on the transparent substrate 51 in the second window 63.

By providing a second polarizer 67 within a second laterally spaced window 63 on the security document 51, the flexible security document 51 may be folded so that the second window 63 overlies the first window 53, thus enabling the orientation pattern in the PPN and LCP layers 54, 56 to be viewed through the second polarizer 67. Therefore, the security document 51 is self-authenticating and no external verification means is required to verify the authenticity of the security device 55.

In a further modified embodiment, the linear polarizer 57 may be replaced by a reflective layer which also enables the security device 55 to be verified by folding the security document 51 so that the polarizer 67 in window 63 overlies the security device 55. In this case, it is not necessary for the security device 55 to be provided in a transparent region or window. Instead, it could be provided on an opacified part of the substrate 51.

The various embodiments of the present invention therefore provide security devices and security documents which may be authenticated either by use of external polarizers, or by a polarizer integrated within the security document itself. The security devices are difficult to copy and provide protection against counterfeiting. Moreover, a security document incorporating the security device is robust and able to withstand folding rough handling which is particularly important for flexible security documents, such as banknotes.

It will be appreciated that various modifications and alterations may be made to the preferred embodiments described above without departing from the scope and spirit of the invention. For instance, instead of an orientating layer in the form of a photo-oriented polymer network (PPN) other types of orientating layers, such as a polyimide material or an orientating layer obtained by oblique sputtering may be used.

1. A security document or device comprising:
a substrate including at least one layer of polymeric material:
an optical component formed by at least one orientating layer and at least one liquid crystal polymer (LCP) layer in contact with the orientating layer; and
an intermediate layer provided between the optical component and the substrate which improves the adhesion of the optical component to the substrate.

2. A security document or device according to claim 1 wherein the intermediate layer comprises a primer layer.

3. A security document or device according to claim 2 wherein the primer layer includes a hydroxyl terminated polymer.

4. A security document or device according to claim 2 or claim 3 wherein primer layer includes a primer selected from the group of:
hydroxyl terminated polyester based co-polymers; or
polyethyleneimine; or
cross-linked hydroxylated acrylates; or
uncross-linked hydroxylated acrylates; or
polyurethanes; or
UV-curing anionic acrylates: or
UV-curing cationic acrylates.

5. A security document or device according to any one of claims 2 to 4 wherein the primer layer includes a cross-linker.

6. A security document or device according to claim 5 wherein the cross-linker is a multifunctional isocyanate.

7. A security document or device according to claim 5 or claim 6 wherein the cross-linker is selected from the group comprising:
isocyanates; or
polyaziridines; or
ziconium complexes; or
aluminium acetylacetone; or
melamines; or
carbodi-imides.

8. A security document or device according to any one of claims 2 to 7 wherein the primer layer does not substantially affect the alignment of the orientating layer.

9. A security document or device according to any one of claims 1 to 8 wherein the substrate is formed from a polymeric material.

10. A security document or device according to any one of claims 1 to 9 wherein the substrate includes at least one base layer of biaxially oriented polymeric material.

11. A security document or device according to claim 10 wherein the substrate includes one or more co-polymer layers on one or both sides of the base layer of biaxially oriented polymeric material.

12. A security document or device according to claim 10 wherein the substrate comprises a base layer of paper with at least one polymeric coating provided on one or both sides of the base layer.

13. A security document or device according to any one of claims 1 to 11 wherein the substrate has a base layer formed from a transparent material.

14. A security document or device according to any one of claims 10 to 13 wherein the substrate further includes at least one opacifying coating applied on at least one side of the base layer.

15. A security document or device according to claim 14 wherein at least one opacifying coating is applied on both sides of the base layer.

16. A security document or device according to either claim 14 or claim 15 wherein the at least one opacifying coating contains at least one opacifying pigment.

17. A security document or device according to claim 16 wherein the opacifying coatings comprise a major proportion of one or more opacifying pigments bound with a minor proportion of a cross-linkable polymeric binder.

18. A security document or device according to either claim 16 or claim 17 wherein the opacifying pigment or pigments are selected from the group including:
titanium dioxide (TiO₂); or
calcium carbonate (CaCO₃); or
barium sulphate (BaSO₄); or
zinc oxide (ZnO).

19. A security document or device according to any one of claims 14 to 18 wherein one or more layers of printed indicia are provided on the opacifying layers.

20. A security document or device according to any one of claims 13 to 19 the at least one opacifying coating completely covers the surface of the transparent substrate.

21. A security document or device according to any one of claims 13 to 19 wherein the at least one opacifying coating partially covers the transparent substrate so as to form a transparent portion or window which is not covered by the opacifying coating.

22. A security document or device according to any one of claims 13 to 19 wherein the at least one opacifying coating partially covers the transparent substrate so as to form two transparent portions or windows which are not covered by the opacifying coating.

23. A security document or device according to any one of claims 1 to 22 wherein the orientating layer and the liquid crystal polymer layer cover the entire surface of the substrate.

24. A security document or device according to any one of claims 1 to 22 wherein the orientating layer and the LCP layer are applied over a selected region or regions of the substrate.

25. A security document or device according to claim 21 or claim 22 wherein the orientating layer and the LCP layer are applied wholly within the area of the window or windows.

26. A security document or device according to claim 21 or claim 22 wherein the orientating layer and the LCP layer are applied partially within and partially outside the area of the window or windows.

27. A security document or device according to claim 21 or claim 22 wherein the orientating layer and the LCP layer are applied wholly outside the window or windows.

28. A security document or device according to any one of claims 1 to 27 wherein the orientating layer is in intimate contact with the LCP layer.

29. A security document or device according to any one of claims 1 to 28 wherein the orientating layer comprises a photo-alignment layer.

30. A security document or device according to claim 29 wherein the photo-alignment layer is a photo-orientated polymer network (PPN).

31. A security document or device according to any one of claims 1 to 28 wherein the orientating layer comprises a polyimide layer rubbed in one direction.

32. A security document or device according to any one of claims 1 to 28 wherein the orientating layer comprises a layer having an orientating effect obtained by oblique sputtering with SiOₓ.

33. A security document or device according to any one of claims 1 to 32 wherein a photo-orientated polymer network is applied to an orientating layer deposited on the substrate.

34. A security document or device according to any one of claims 1 to 33 wherein the LCP layer comprises an anisotropic layer of orientated cross-linked liquid crystal monomers.

35. A security document or device according to any one of claims 1 to 34 wherein molecules of the LCP layer have an orientation determined by the orientation of the underlying orientating layer.

36. A security document or device according to any one of claims 1 to 34 wherein molecules of the LCP layer have an orientation transferred from the orientating layer to the LCP layer.

37. A security document or device according to claim 34 wherein the LCP layer is photo-cross-linked by the action of light of a suitable wavelength and retains the orientation of molecules predetermined by the orientating layer.

38. A security document or device according to any one of claims 1 to 37 including further orientating layers and/or LCP layers.

39. A security document or device according to claim 38 wherein the security device includes a second orientating layer on the first LCP layer.

40. A security document or device according to claim 39 wherein the security device includes a second LCP layer on the second orientating layer.

41. A security document or device according to either claim 39 or claim 40 wherein the second orientating layer comprises a photo-orientated polymer network.

42. A security document or device according to any one of claims 38 to 41 wherein two or more orientating layers and LCP layers having different orientation patterns are provided to form a stack of orientation layers and LCP layers on a substrate.

43. A security document or device according to any one of claims 1 to 42 further including a reflector layer.

44. A security document or device according to claim 43 wherein the reflector layer is a reflective metallic layer.

45. A security document or device according to any one of claims 1 to 42 further including a polarizing layer.

46. A security document or device according to claim 45 wherein the polarising layer is a photo oriented polymer network (PPN) with a liquid crystal polymer (LCP) and a cross-linked dichroic dye added to form the polariser.

47. A security document or device according to claim 45 or claim 46 wherein the polarising layer is a linear polarizer.

48. A security document or device according to any one of claims 43 to 47 wherein the linear polarizer is located between the orientation layer and the substrate.

49. A security document or device according to any one of the preceding claims wherein the optical component formed by the combination of the LCP layer(s) and orientation layer(s) contains at least one hidden image.

50. A security document or device according to claim 49 wherein the hidden image is successively revealed and concealed when the optical component is held between two polarizers and one of the polarizers is rotated.

51. A security document according to claim 43 or claim 44 wherein the optical component is provided at a first location with a reflector or polarizing layer and a polariser is provided in a window at a second, laterally spaced location so that the security document is self-authenticating by folding the document to bring the windows into register.

52. A security device according to any one of claims 1 to 50 wherein the device is adapted for attachment to another article.

53. A method of manufacturing a security document or device comprising:
providing a substrate which includes at least one layer of polymeric material;
applying a primer layer on at least one side of the substrate;
applying an orientating layer over the prime layer;
aligning the molecules of the orientating layer; and
applying a liquid crystal polymer (LCP) layer over the orientating layer.

54. A method according to claim 53 wherein the step of applying the primer layer is performed by applying a primer including a polymer component and a cross-linker.

55. A method according to claim 43 wherein the primer includes a hydroxyl terminated polymer.

56. A method according to claim 54 or claim 55 wherein the cross-linker is a multifunctional isocyanate.

57. A method according to any one of claims 53 to 56 wherein the step of applying the orientating layer over the primer layer is performed by applying a solution containing a photo orientating polymer network (PPN) over the primer layer.

58. A method according to claim 57 further including the step of drying the substrate to remove solvent from the PPN solution wherein a strong adhesive bond is formed between the orientating layer and the substrate.

59. A method according to any one of claims 53 to 58 wherein the orientating layer includes a photoalignment layer and further including the step of exposing the photoalignment layer to polarized light to align the molecules of the photoalignment layer.

60. A method according to claim 59 wherein the photoalignment layer is subjected to a first exposure of polarized light through a mask to form local regions having a first orientation of molecules.

61. A method according to claim 60 wherein the photoalignment layer is subjected to a second exposure without a mask using a different component of the polarized light to form local regions having a second orientation to form an orientation pattern in the orientating layer.

62. A method according to claim 59 wherein an orientation pattern is formed in the photoalignment layer and/or the LCP layer without the use of a mask.

63. A method according to claim 62 wherein the orientation pattern is formed by a variable printing process.

64. A method according to claim 62 wherein the orientation pattern is formed by a laser writing process.

65. A method according to any one of claims 53 to 64 wherein the LCP layer is formed by applying a coating of liquid crystal monomers to the orientating layer such that the liquid crystal molecules assume the orientation of the molecules of the underlying orientating layer, and cross linking the monomers to fix the orientation of the liquid crystal molecules.

66. A method according to claim 65 further including the step of applying a second orientating layer on the LCP layer.

67. A method according to claim 66 further including the step of applying a second LCP layer on the second orientating layer in a similar manner as the first orientating layer is applied to the primer layer on the substrate.

68. A method according to claim 67 wherein the second orientating layer is exposed to linear polarized light through a mask having a different pattern to the mask used to produce the orientation pattern in the first orientating layer to produce a different orientation pattern in the second orientating layer.
